(19) United States
(12) Patent Application Publication
(10) Pub. No.: US 2006/0008275 A1
(43) Pub. Date: Jan. 12, 2006

(54) Apparatus and method for transmitting data in an aqueous medium

(76) Inventors: Philip Lacovara, Tucson, AZ (US); Rogelio Rodriguez, Vail, AZ (US); Lavirboth Cheav, Tucson, AZ (US)

Correspondence Address: Lawrence R. Oremland, P.C., Suite C-214, 5055 East Broadway Blvd., Tucson, AZ, 85711, US

(21) Appl. No.: 10/962,650

(22) Filed: Oct. 12, 2004

Related U.S. Application Data
(60) Provisional application No. 60/510,106, filed on Oct. 9, 2003.

(51) Int. Cl. H04B 10/00

(52) U.S. Cl. 398/140

(57) ABSTRACT

An apparatus and method for transmitting data in an aqueous medium is provided. The apparatus, comprising a transmitter having one or a plurality of LED transmitting components, which is configured, when immersed in an aqueous medium, to transmit light in a blue or green light wavelength, and a receiver configured, when immersed in the aqueous medium, to receive light in the wavelength of the transmitter.

### RELATED APPLICATIONS/CLAIM OF PRIORITY

This application is related to and claims priority from Provisional Application Ser. No. 60/510,106, filed Oct. 9, 2003.

### GOVERNMENT RIGHTS

This invention may have been at least partially supported by funding under US Government Contract No. N66604-02-C-5379 and/or N00039-3-C-0087 (a Phase II SBIR contract by the Space and Naval Warefare Systems Command). The government may have some rights in this invention.

### SUMMARY OF THE PRESENT INVENTION

An apparatus and method for transmitting data in an aqueous medium, comprising a transmitter having one or a plurality of LED transmitting components, which is immersed in an aqueous medium and which is configured to transmit light in a blue or green light wavelength, and a receiver that is immersed in the aqueous medium and is configured to receive light in the wavelength of the transmitter.

### BRIEF DESCRIPTION OF THE DRAWINGS

FIG. 1 is a schematic illustration of a pair of transmitters and receivers according to the present invention;

FIG. 2 is a schematic illustration of an array of LED transmitting components for transmitting data underwater, according to the principles of the present invention;

FIG. 3 is a schematic illustration a transmitter/receiver assembly for transmitting data from transmitter sub arrays having different orientations relative to a receiver;

FIG. 4 is a schematic illustration of a control device for a transmitter/receiver assembly according to the present invention; and

FIG. 5 is a schematic illustration of a receiver implementation which provides 2-pi azimuthal sensitivity with no moving parts.

### DETAILED DESCRIPTION

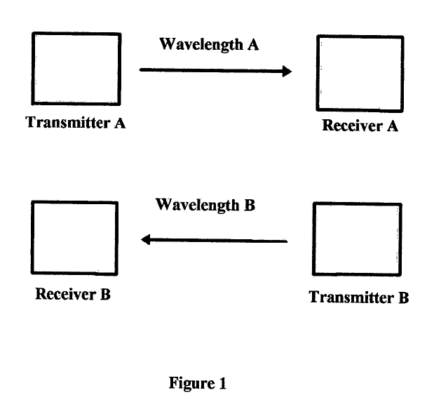

The present invention utilizes one or a pair of optical transmitters and one or a pair of optical receivers to transmit data between two locations, underwater. Bi-directional transmission is accomplished using two different wavelengths, as shown in FIG. 1. The transmitters and receivers, denoted as “A” and “B”, will generally be chosen to transmit at discrete wavelengths so separated that by the judicious use of optical filters, as apparent to one schooled in the art, interference of one transmitter with its adjacent receiver such as might be caused by optical backscatter can be prevented. For example, referring to FIG. 1, transmitter A may transmit and receiver A may receive data at a blue wavelength or group of wavelengths, such as 470 nm, and transmitter B may transmit and receiver B may receive data at a green wavelength or group of wavelengths, such as 520 nm. The choice of wavelengths will be motivated by the properties of the water and the choice of optical filter. Typically, operation in clearer ocean waters will favor operation at bluer wavelengths, while operation in more turbid, coastal waters will favor operation at greener wavelengths.

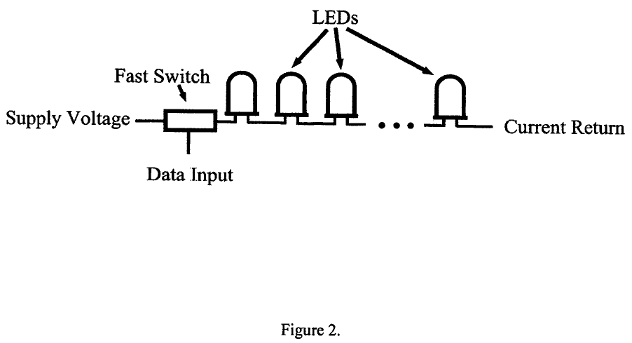

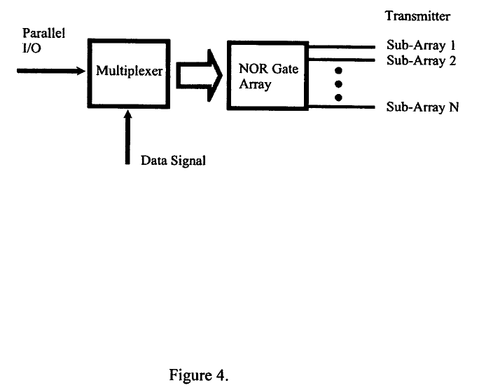

In order to obtain longer transmission range and higher efficiency the respective transmitters may be composed of arrays of light-emitting diodes (LEDs), which are available operating with a range of output powers, angular distributions, and output wavelengths. By using an array of LEDs the overall output power of a transmitter may be increased compared to that generated by a single LED by a factor equal to the number of LEDs in the array. These LEDs may be arranged in groups with appropriate switching and current-regulation circuits such that they can be operated with the required stability and temporal performance to support the desired data rate. An appropriate choice of LED would be the Agilent HLMP-CB15 for blue transmission, and the HLMP-CE15 for green transmission. The LEDs may be used in arrays comprising e.g. 10-30 LEDs arranged in series strings (see e.g. FIG. 2), with multiple series strings controlled in parallel for data transmission. The LEDs may be used in arrays comprising multiple LEDS arranged in series strings, with multiple series strings controlled in parallel through a fanout or multiplexing circuit for data transmission (see e.g. FIG. 4). Alternatively, the subarray strings may comprise a plurality of semiconductor lasers such as the Nichia NDHA500APAE1 operating at a nominal wavelength of 470 nm, although the high cost of semiconductor lasers operating in the blue-green spectral region compared to equivalent LEDs might prevent the wide use of these devices.

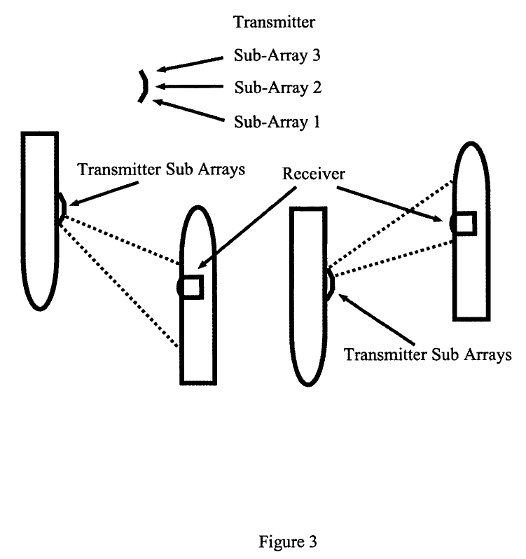

Some communications applications, such as between Unmanned Underwater Vehicles (UUVs), could require pointing of a transmitter in the direction of a receiver. The use of mechanical pointing, such as with a gimbaled mirror, leads to large, heavy and expensive opto-mechanical assemblies. The low-cost of LED arrays (and potentially, of semiconductor laser arrays) makes it possible to direct the transmitter light selectively into different angular directions by activating a particular sub-arrays, composed of a string or collection of strings that are pointed in the desired direction, while not activating sub-arrays pointed in the undesired direction. In practice, and as seen from FIG. 3, the transmitter array would comprise a plurality of sub-arrays, with their mechanical mounting arranged so that the emission angles of each individual device or string within the sub-array are directed into contiguous or overlapping angular directions (which are represented in FIG. 3 by dashed lines). The number and arrangement of the individual sub-arrays would be sufficient to completely encompass the entire range of desired transmission angles.

Thus, as shown in FIGS. 3 and 4, a transmitter comprises a plurality of sub arrays of optical transmitting elements arranged so as to direct their output into different angular directions, and the sub arrays of transmitting elements can be independently controlled so as to select the angular direction of transmission by activating the desired transmitting element or sub array of transmitting elements. FIG. 4 illustrates the manner in which the sub arrays of transmitting elements can be independently controlled. A multiplexer is used to direct the incoming data signal into one of a series of output lines in response to a digital input byte supplied by a control processor (not shown). A NOR gate array is used to convert the data-signal outputs from the multiplexer to normally-low levels so that the data signal outputs, which are now used to activate the output of the transmitter sub-arrays, are active only when a data signal is being transmitted.

The use of the non-mechanical transmitter scanning technique described herein would lead to lower-cost and lower-power-consumption communications devices

The receiver may typically comprise a collecting lens and a photomultiplier tube detector such as the Hamamatsu R7400U, with associated power supplies and signal amplification well known to those schooled in the art to provide useful data output. Optical filtering for the purpose of wavelength discrimination between the two channels may be accomplished with one or a combination of interference, colored glass or plastic filters placed before the receiver. In addition, if it is desired to have the receiver work over a wide range of illumination levels (e.g. if the receiver is intended to move toward and away from the transmitter), an automatic gain control device can be used, as will be appreciated by those in the art.

In order to operate in the intended aqueous medium, the transmitter and receiver will typically be packaged within a pressure vessel or similar structure designed to withstand the pressure of the external aqueous medium and prevent damage to internal components, as is well known to those schooled in the art. Such a pressure vessel could comprise a cylindrical tube designed to withstand the intended external pressure, with end caps similarly designed, one of which will have suitably mounted within it a pressure-resistant window capable of transmitting the desired optical wavelengths. Said pressure vessel would also include waterproof connectors or other mechanisms for allowing the exchange of power, data and control signals with an external device without compromising the water-proof integrity of the pressure vessel. It is also possible under some embodiments to dispense with the separate pressure vessel and instead encapsulate the transmitter and/or receiver components in a polymeric material such as polyurethane that is both waterproof and structurally strong enough to withstand the required external pressure of the aqueous medium, while also transparent to the desired optical wavelengths.

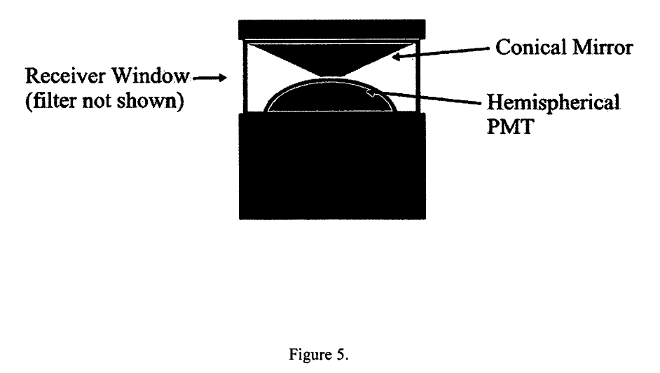

In another implementation shown in FIG. 5 the receiver may comprise a hemispherical photomultiplier tube detector (PMT), such as the Hamamatsu R5912, mounted in a vertical orientation with respect to the axis of a cylindrical pressure vessel comprising a clear receiver window section made of, for example, acrylic. As with the preceding example the receiver would include high-voltage power supplies for the photomultiplier tube, as well as signal amplification circuitry and optical filters for the rejection of light outside of the spectral band of use for its respective transmitter. A conical mirror can be mounted on axis above the light-sensitive end of the photomultiplier tube in order to improve light collection efficiency. Such a receiver embodiment has the benefit of sensitivity over an entire 2-pi azimuthal range.

Thus, the present invention provides an apparatus and method for transmitting data in an aqueous medium, comprising a transmitter having one or a plurality of solid-state transmitting components, which is configured, when immersed in an aqueous medium, to transmit light in a blue or green light wavelength, and a receiver configured, when immersed in the aqueous medium, to receive light in the wavelength of the transmitter. The transmitter can comprise a plurality of optical transmitting elements which are arranged so as to direct their output into different angular directions (see e.g. FIG. 3), and where the transmitting elements can be independently controlled so as to select the angular direction of transmission by activating the desired transmitting element or elements (see e.g. FIG. 4). Preferably, two transmitter and receiver pairs at two separate wavelengths are used in order to accomplish full-duplex data transmission (see e.g. FIG. 1), and the transmitter preferably utilizes a plurality of LEDs which are controlled from a common signal sources so as to increase the output power of the transmitter (see e.g. FIG. 2). Also, the transmitter can utilize a single LED for each angular direction, or a plurality of LEDs for each angular direction. Alternatively, the transmitter can utilize a single semiconductor laser for each angular direction, or the transmitter can utilize a plurality of semiconductor lasers for each angular direction.

With the foregoing disclosure in mind, various ways of communicating data in an aqueous medium will become apparent to those in the art.

What is claimed is:

1. An apparatus for transmitting data in an aqueous medium, comprising a transmitter having one or a plurality of solid-state transmitting components, which is configured to transmit light in a blue or green light wavelength, and a receiver configured to receive light in the wavelength of the transmitter.

2. The apparatus of claim 1 wherein the transmitter comprises a plurality of optical transmitting elements which are arranged so as to direct their output into different angular directions, and where the transmitting elements can be independently controlled so as to select the angular direction of transmission by activating the desired transmitting element or elements.

3. The apparatus of claim 1 wherein two transmitter and receiver pairs at two separate wavelengths are used in order to accomplish full-duplex data transmission.

4. The apparatus of claim 1 wherein the transmitter utilizes a plurality of LEDs which are controlled from a common signal sources so as to increase the output power of the transmitter.

5. The apparatus of claim 2 wherein the transmitter utilizes a single LED for each angular direction.

6. The apparatus of claim 2 wherein the transmitter utilizes a plurality of LEDs for each angular direction.

7. The apparatus of claim 2 wherein the transmitter utilizes a single semiconductor laser for each angular direction.

8. The apparatus of claim 2 wherein the transmitter utilizes a plurality of semiconductor lasers for each angular direction.

9. The apparatus of claim 1 wherein the receiver utilizes a hemispherical photomultiplier tube oriented so as to provide continuous sensitivity over 2-pi azimuth.

10. A method for transmitting data in an aqueous medium, comprising the steps of providing a transmitter having one or a plurality of solid-state transmitting components, which is configured to transmit light in a blue or green light wavelength, and a receiver configured to receive light in the wavelength of the transmitter, immersing the transmitter and the receiver in an aqueous medium and transmitting data from the transmitter to the receiver in the aqueous medium in the blue or green wavelength for which the transmitter is configured.

11. The method of claim 10 wherein the transmitter comprises a plurality of optical transmitting elements which are arranged so as to direct their output into different angular directions, and where the transmitting elements are independently controlled while in the aqueous medium so as to select the angular direction of transmission by activating the desired transmitting element or elements.

12. The method of claim 10 wherein two transmitter and receiver pairs at two separate wavelengths are immersed in the aqueous medium and are used to transmit data in the aqueous medium in order to accomplish full-duplex data transmission.

13. The method of claim 10 wherein the transmitter utilizes a plurality of LEDs which are controlled from a common signal sources so as to increase the output power of the transmitter.

14. The method of claim 11 wherein the transmitter utilizes a single LED for each angular direction.

15. The method of claim 11 wherein the transmitter utilizes a plurality of LEDs for each angular direction.

16. The method of claim 11 wherein the transmitter utilizes a single semiconductor laser for each angular direction.

17. The method of claim 11 wherein the transmitter utilizes a plurality of semiconductor lasers for each angular direction.

18. The method of claim 10 wherein the receiver utilizes a hemispherical photomultiplier tube oriented so as to provide continuous sensitivity over 2-pi azimuth.
